(19) United States
(12) Patent Application Publication
(10) Pub. No.: US 2003/0221165 A1
(43) Pub. Date: Nov. 27, 2003

(54) System and method for metadata-driven user interface

(75) Inventors: Jeffrey Scott Young, Waterville, OH (US); Patrick Edwin Plaisted, Rawson, OH (US); Patrick Jude Gibson, Findlay, OH (US); Shane Lee Griggs, Hilliard, OH (US); Timothy James Brookins, West Fargo, ND (US); Craig Lane Carlson, Fargo, ND (US)

Correspondence Address: William O. Isaacs, II, Esq., KING & SPALDING, 45th Floor, 191 Peachtree Street, N.E., Atlanta, GA, 30303, US

(73) Assignee: Microsoft Corporation, Redmond, WA

(21) Appl. No.: 10/153,036

(22) Filed: May 22, 2002

(51) Int. Cl. G09G 5/00

(52) U.S. Cl. 715/505

(57) ABSTRACT

A user interface comprising one or more fields can be generated based on metadata in program logic. The field can be provided in a smart object through object oriented programming. Smart object metadata indicating an attribute of the field can be embedded in the smart object. Logical form metadata identifies a data type associated with the field, and layout metadata identifies a location of the field on the user interface. Physical control metadata identifies a physical control to represent the field on the user interface, and physical settings metadata identifies presentation characteristics of the physical control. The field can be generated on the user interface by displaying the physical control identified by the physical control metadata in the location identified by the layout metadata, with the attribute identified in the smart object metadata, and having the characteristics identified in the physical settings metadata.

### TECHNICAL FIELD

The present invention relates generally to computer systems and programs. More particularly, the present invention relates to a system and method for generating a user interface based on metadata provided in program logic.

### BACKGROUND OF THE INVENTION

Enterprise level business application programs can contain millions of lines of application program logic. That application program logic can be produced through object oriented programming, resulting in objects that contain data for executing the application program. A user interface presents the application program logic to a user and allows interaction between the application program and the user.

The design architecture of a conventional user interface typically includes controls bound to the application program logic. The controls provide the physical presentation of the application program logic on the user interface and allow the user to interact with the application program. Such controls can include a text box, a radio button, a look-up table, and other items displayed on the user interface. A programmer uses computer code to bind the controls to the application program logic. In that process, the code typically replicates portions of the application program logic, especially in a rich, interactive user interface environment. Such computer code that binds the controls to the application program logic is termed “glue code.”

The conventional glue code method of creating a user interface has several disadvantages. For example, using glue code can increase the cost of constructing the user interface. The glue code method involves high labor costs because a programmer must hand-write the glue code that binds the controls to the logic. Additionally, the glue code typically duplicates code that exists in the application program logic, thereby duplicating the effort and cost involved in producing the complete product.

For example, the application program logic includes requirements regarding the sequence in which controls for objects can be accessed on a user interface. For instance, on a sales order screen of a user interface, the customer must be selected before line items can be added, because pricing for line items is dependent on the particular customer. The currency of the order also must be selected before line items are added, because pricing varies by currency. Additionally, the customer must be selected before the currency, because not all currencies are available for all customers. The application program logic includes code that enforces those dependencies and state requirements. The application program logic will present an error if a client of the logic calls the items in the wrong order.

However, the user interface needs to know those state requirements without actually trying to set the properties. Accordingly, the user interface can disable controls that are not currently valid for input, rather than letting the user try to enter data into a non-valid control and then issuing an error. Conventional user interfaces cannot obtain information from the object regarding which controls should be disabled. Instead, the programmer must write redundant code on the user interface that mimics the state needs of the object to enable and disable controls at the right times. Accordingly, the user interface includes duplicate code of the state of the objects.

Other duplicative functions performed by glue code include error-checking and defaulting. Controls typically perform immediate error checks to provide an interactive experience to the user. The application program logic in the objects includes the error-checking of values. The glue code tying the user interface to the program logic also performs error-checking. Accordingly, the error-checking glue code duplicates the application program logic.

In defaulting, a control typically is defaulted to a value based on the value entered in other controls. For example, when a customer is selected for an order, the currency of the order should default to the home currency of the customer. In a user interface designed to provide an interactive experience, most controls should default as the user fills in the order. Both the application program logic and the glue code contain the default logic, which is a duplication of the work product.

Using glue code to produce a user interface also increases the expense of testing the user interface. Because complex logic application programs have so much investment tied into their application program logic, it is a common desire to leverage that investment across multiple product lines. For example, both a high-end and a low-end product with different exposed functionality and pricing can be produced using the core application program logic. Accordingly, multiple unique user interfaces are constructed for a common set of underlying core application program logic to provide the different products. Each user interface exposes different functionality and provides different usage scenarios. However, the underlying complex core logic is leveraged across each product. Because the user interface relies on significant amounts of hand-written glue code, designers must perform exhaustive testing of the glue code that ties the user interface to the application logic. Such testing is time consuming and costly.

Glue code based user interfaces also decrease the maintainability of the user interface. Glue code for the user interface is sensitive to changes in the application logic. Each change in application logic functionality requires changes in the associated glue code on the user interface. For example, the functionality of the glue code must be changed to duplicate any functionality changes in the application logic.

Glue code based user interfaces also hinder product customizations. Typically, a user wants to customize an application program to a specific business or function. Similar to the maintenance issue discussed above, changes to the application program logic may require a change in the glue code for the user interface. Additional testing is also required to implement the changed user interface.

Using glue code to develop a user interface does not allow blanket user interface modifications. Many software developers want the “look and feel” of their software to change from version to version. Those changes may be stylistic and may not increase the product functionality. For example, a first version may have two-dimensional buttons on the user interface, while the programmer desires that a second version have three-dimensional buttons. A modern application program can include over 1,000 screens in the total product offering. A blanket change of the buttons in each screen would require rewriting the glue code for each screen.

Therefore, there is a need in the art for an improved system and method for generating a user interface. A need exists in the art for a system and method for generating a user interface without duplicating the core logic of the application program. Additionally, a need exists in the art for a user interface that does not duplicate the testing of the core logic. A need also exists for a system and method that can implement blanket modifications to multiple user interface screens through a central change to the application program logic, without modifying code for each screen.

### SUMMARY OF THE INVENTION

The present invention relates generally to a system and method for generating a user interface for a program module, such as an application program of an operating system. The present invention can generate a user interface without duplicating the core logic of the application program. Accordingly, the present invention can provide an easily maintainable and testable user interface. Additionally, the present invention can provide for modification of multiple user interface screens through a central change to data in the program logic. Accordingly, individual changes to each screen are not needed.

The present invention can provide a smart object metadata driven user interface framework. The software architecture of that framework can develop user interfaces bound to complex logic in smart objects, without duplicative code that ties the user interface and the logic. The smart objects can provide metadata that describes specific behavioral patterns to the user interface framework. The user interface framework then can create user interfaces without hand-coding specific functionality into the user interface layer itself. Accordingly, the present invention can allow non-functional testing of the user interface and functional testing of the application program logic.

In an exemplary aspect of the present invention, a user interface can comprise a field displayed on a screen. The field can be provided in a smart object through object oriented programming. State metadata for the field can be embedded in the smart object. The state metadata can indicate an attribute of the field. For example, the state metadata can indicate whether the state of the field is “must write,” “read/write,” or “read only.” Logical form metadata can be developed for the field of the smart object. The logical form metadata can identify a data type associated with the field. For example, the data type can be “text.” Layout metadata also can be developed for the field. The layout metadata can identify a location of the field on the user interface. Physical control metadata can be assigned to the field. The physical control metadata can identify a physical control to represent the field on the user interface. The physical control can be of the data type indicated by the logical form metadata. Physical settings metadata can be assigned to the physical control. The physical settings metadata can identify presentation characteristics of the physical control. For example, the physical settings metadata can identify “Arial” as the font style for a text box physical control. Then, the field can be generated on the user interface by displaying the physical control identified by the physical control metadata in the location identified by the layout metadata and with the state identified in the state metadata. The physical control can have the characteristics identified in the physical characteristics metadata.

These and other aspects, objects, and features of the present invention will become apparent from the following detailed description of the exemplary embodiments, read in conjunction with, and reference to, the accompanying drawings.

### BRIEF DESCRIPTION OF THE DRAWINGS

FIG. 1 is a block diagram illustrating an exemplary computer suitable for practicing an exemplary embodiment of the present invention.

FIG. 2 is a block diagram depicting a system architecture for generating a user interface using smart object metadata according to an exemplary embodiment of the present invention.

FIG. 3 is a flowchart depicting a method for generating a user interface using smart object metadata according to an exemplary embodiment of the present invention.

FIG. 4 is a flowchart depicting a method for embedding state metadata for fields smart object according to an exemplary embodiment of the present invention.

FIG. 5 is a flowchart depicting a method for developing logical form metadata according to an exemplary embodiment of the present invention.

FIG. 6 is a flowchart depicting a method for developing layout metadata according to an exemplary embodiment of the present invention.

FIG. 7 is a flowchart depicting a method for assigning physical control metadata according to an exemplary embodiment of the present invention.

FIG. 8 is a flowchart depicting a method for assigning physical settings metadata according to an exemplary embodiment of the present invention.

FIG. 9 is a flowchart depicting a method for generating a user interface form on a user interface according to an exemplary embodiment of the present invention.

### DETAILED DESCRIPTION OF THE EXEMPLARY EMBODIMENTS

The present invention can provide a smart object metadata driven user interface framework. The framework can generate a user interface based on metadata provided in the program logic, without using duplicative glue code to bind the user interface to the logic. The program logic can include smart object metadata, logical form metadata, layout metadata, physical control metadata, and physical settings metadata. A renderer can read and combine information from the metadata items to generate the form displayed on the user interface. Changes can be made to multiple user interfaces by changing a central occurrence of metadata in the program logic.

Referring now to the drawings, in which like numerals represent like elements throughout the figures, aspects of the present invention and the preferred operating environment will be described.

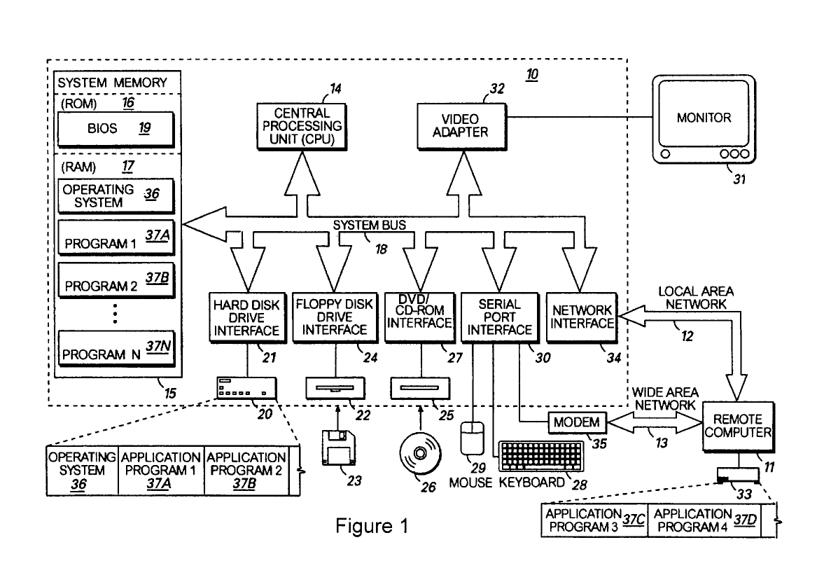

FIG. 1 illustrates various aspects of an exemplary computing environment in which the present invention is designed to operate. Those skilled in the art will appreciate that FIG. 1 and the associated discussion are intended to provide a brief, general description of the preferred computer hardware and program modules, and that additional information is readily available in the appropriate programming manuals, user's guides, and similar publications.

FIG. 1 illustrates a conventional the personal computer 10 suitable for supporting the operation of embodiments of the present invention. As shown in FIG. 1, the personal computer 10 operates in a networked environment with logical connections to a remote server 11. The logical connections between the personal computer 10 and the remote server 11 are represented by a local area network 12 and a wide area network 13. Those of ordinary skill in the art will recognize that in this client/server configuration, the remote server 11 may function as a file server or computer server.

The personal computer 10 includes a processing unit 14, such as “PENTIUM” microprocessors manufactured by Intel Corporation of Santa Clara, Calif. The personal computer 10 also includes a system memory 15, including read only memory (ROM) 16 and random access memory (RAM) 17, which is connected to the processor 14 by a system bus 18. An exemplary embodiment of computer 10 utilizes a BIOS 19, which is stored in the ROM 16. Those skilled in the art will recognize that the BIOS 19 is a set of basic routines that helps to transfer information between elements within the personal computer 10. Those skilled in the art will also appreciate that the present invention may be implemented on computers having other architectures, such as computers that do not use a BIOS, and those that utilize other microprocessors.

Within the personal computer 10, a local hard disk drive 20 is connected to the system bus 18 via a hard disk drive interface 21. A floppy disk drive 22, which is used to read or write a floppy disk 23, is connected to the system bus 18 via a floppy disk drive interface 24. A CD-ROM or DVD drive 25, which is used to read a CD-ROM or DVD 26, is connected to the system bus 18 via a CD-ROM or DVD interface 27. A user enters commands and information into the personal computer 10 by using input devices, such as a keyboard 28 and/or pointing device, such as a mouse 29, which are connected to the system bus 18 via a serial port interface 30. Other types of pointing devices (not shown in FIG. 1) include track pads, track balls, pens, head trackers, data gloves, and other devices suitable for positioning a cursor on a computer monitor 31. The monitor 31 or other kind of display device is connected to the system bus 18 via a video adapter 32.

The remote server 11 in this networked environment is connected to a remote memory storage device 33. The remote memory storage device 33 is typically a large capacity device such as a hard disk drive, CD-ROM or DVD drive, magneto-optical drive or the like. Those skilled in the art will understand that program modules, such as application program modules 37C and 37D, are provided to the remote server 11 via computer-readable media. The personal computer 10 is connected to the remote server 11 by a network interface 34, which is used to communicate over the local area network 12.

In an alternative embodiment, the personal computer 10 is also connected to the remote server 11 by a modem 35, which is used to communicate over the wide area network 13, such as the Internet. The modem 35 is connected to the system bus 18 via the serial port interface 30. The modem 35 also can be connected to the public switched telephone network (PSTN) or community antenna television (CATV) network. Although illustrated in FIG. 1 as external to the personal computer 10, those of ordinary skill in the art can recognize that the modem 35 may also be internal to the personal computer 10, thus communicating directly via the system bus 18. It is important to note that connection to remote server 11 via both the local area network 12 and the wide area network 13 is not required, but merely illustrates alternative methods of providing a communication path between the personal computer 10 and the remote server 11.

Although other internal components of the personal computer 10 are not shown, those of ordinary skill in the art will appreciate that such components and the interconnection between them are well known. Accordingly, additional details concerning the internal construction of the personal computer 10 need not be disclosed in connection with the present invention.

Those skilled in the art will understand that program modules, such as an operating system 36, a representative application program module 37A, a browser application program module 37B, other program modules 37N, and data are provided to the personal computer 10 via computer-readable media. The program modules 37N can comprise application programs that can provide a metadata-driven user interface on the monitor 31 according to an exemplary embodiment of the present invention. In an exemplary computer 10, the computer-readable media include the local or remote memory storage devices, which may include the local hard disk drive 20, floppy disk 23, CD-ROM or DVD 26, RAM 17, ROM 16, and the remote memory storage device 33. In another exemplary personal computer 10, the local hard disk drive 20 is used to store data and programs.

The processes and operations performed by the computer 10 include the manipulation of signals by a client or server and the maintenance of these signals within data structures resident in one or more of the local or remote memory storage devices. Such data structures impose a physical organization upon the collection of data stored within a memory storage device and represent specific electrical or magnetic elements. These symbolic representations are the means used by those skilled in the art of computer programming and computer construction to most effectively convey teachings and discoveries to others skilled in the art.

The present invention also includes a computer program which embodies the functions described herein and illustrated in the appended flow charts. However, it should be apparent that there could be many different ways of implementing the invention in computer programming, and the invention should not be construed as limited to any one set of computer program instructions. Further, a skilled programmer would be able to write such a computer program to implement the disclosed invention based on the flow charts and associated description in the application text. Therefore, disclosure of a particular set of program code instructions is not considered necessary for an adequate understanding of how to make and use the invention. The inventive functionality of the claimed computer program will be explained in more detail in the following description in conjunction with the remaining figures illustrating the program flow.

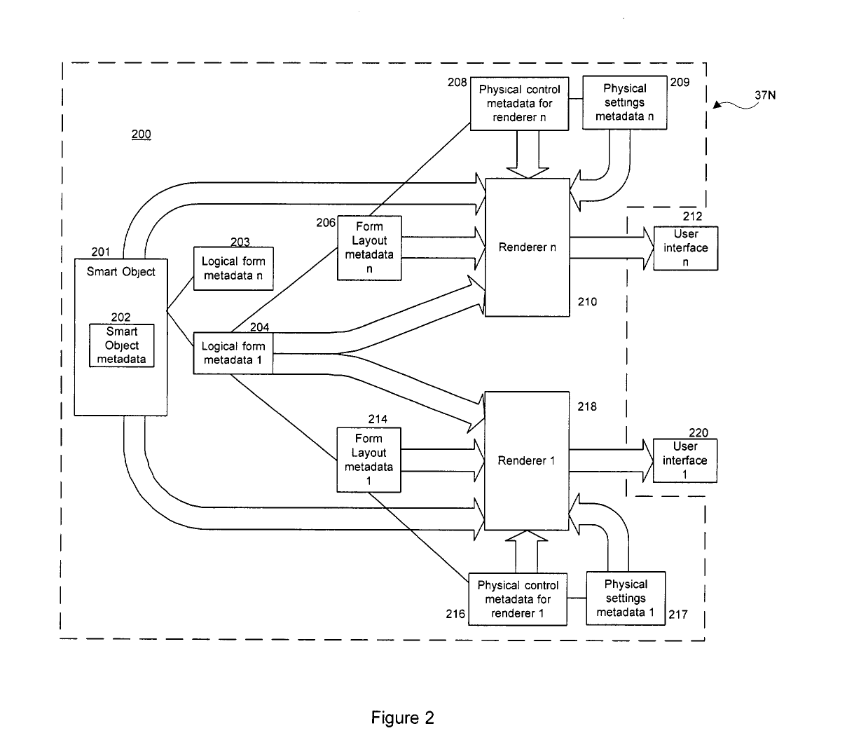

FIG. 2 is a block diagram depicting a system 200 for generating a user interface using smart object metadata according to an exemplary embodiment of the present invention. Although not depicted in FIG. 2, each metadata item can be provided in a program module 37N (FIG. 1). As shown in FIG. 2, system 200 can include a smart object 201 comprising smart object metadata 202. The smart object 201 can be an object including fields and can be established through object oriented programming. Accordingly, the smart object 201 can comprise data typically associated with an object established through object oriented programming. Additionally, the smart object 201 can comprise the smart object metadata 202. Fields of the smart object 201 can be referenced by a field ID in the smart object metadata 202. Each field can comprise a smart object within smart object 201.

The smart object metadata 202 can indicate a state of a field in the smart object 201. The state of the field can indicate which operations are valid for the field. For example, the state can indicate whether the field is “must write” (required and not currently entered), “read/write” (enabled control), or “read only” (disabled control). The smart object metadata 202 also can provide other information. For example, the smart object metadata also can provide an entry format, a display format, a maximum keyable length, and a help link. The entry format can specify the format in which the data should be entered. For example, a social security number requires a format of ###-##-####. The format can force the information entered into the field into the specified pattern. The display format can specify the format in which data should be displayed to the user within the control. For example, dates can be displayed in MM/DD/YYYY format or DD/MM/YYYY format. The maximum keyable length can define the maximum number of characters that can be entered in a particular field. For example, a U.S. phone number should allow only 10 characters to be entered. The help link can specify a link to a help file. The link can be a uniform resource locator (URL). Other information is within the scope of the present invention.

In an exemplary embodiment, smart object 201 can comprise a customer object of a business application program. The customer object can comprise fields established by object oriented programming. For example, the fields can comprise customer name, customer identification (ID) number, address, city, state, zip code, e-mail address, credit card number, and other fields associated with customer information. Each field can be assigned a field ID. For example, the customer name field can be assigned a field ID of “customer_nameID.” The smart object metadata 202 for the customer object can indicate the state of each field. For example, the smart object metadata 202 can associate customer_nameID with a state of “must write” if the customer name field is currently empty. Accordingly, a user can be required to enter a name into the customer name field. Additionally, the state of a field provided in the smart object metadata 202 can change during execution of the business application program. For example, the state of the customer name field can change from “must write” to “read/write” after entry of a name in the customer name field. Accordingly, the user can read and edit the name entered into the customer name field.

In an exemplary embodiment, smart object metadata 202 can be provided for a group of fields having the same state. Each field having the same state would not require its own smart object metadata. The respective field ID of each field can be mapped to the smart object metadata that indicates the common state. Accordingly, the total amount of smart object metadata 202 can be reduced.

The system 200 also can include one or a plurality of logical form metadata 203, 204 associated with the smart object 201 and the smart object metadata 202. Each logical form metadata 203, 204 can represent a form (such as a user interface screen) that can be displayed on a user interface 212, 220. The user interface 212, 220 can comprise computer application programs. For example, the computer application programs can comprise Microsoft® Internet Explorer, Microsoft® Win32® applications, web phones, and other application programs. Alternatively, the user interface 212, 220 can comprise the monitor 31 (FIG. 1), a printer (not shown), or other output device (not shown). Each logical form metadata 203, 204 can be associated with a particular form for presentation on the user interface 212, 220. Additionally, each logical form metadata 203, 204 can be associated with fields from the smart object 201 or other smart objects (not shown) for display on the user interface 212, 220. The logical form metadata 203, 204 can comprise the business component relationship information for the form. The logical form metadata 203, 204 can describe the fields that can be displayed on the form and how the fields map to the properties or methods on a business component.

For example, the logical form metadata 203 can comprise information for a customer maintenance form in which fields relating to customer maintenance can be displayed on the user interface 212, 220. The fields can originate in the exemplary customer object described above. For the exemplary customer maintenance form, the fields can comprise the customer name, customer ID, address, city, state, zip code, phone number, credit card number, e-mail address, and other fields related to customer information. Continuing with the example, the logical form metadata 204 can comprise information for a customer order form in which fields relating to a customer order can be displayed. For the exemplary customer order form, the fields can include the customer name and customer ID from the exemplary customer object described above. Additionally, the logical form metadata 204 can reference fields from other smart objects. For example, additional fields for the exemplary customer order form can include an order number, invoice line items, inventory items, and salesperson information.

Each field in the logical form metadata 203, 204 can have its field ID mapped to a logical type identifier. The logical type identifier can relate to the type of information in the field and can identify a type of physical control to use when displaying the field on the user interface 212, 220. For example, the customer name field of the exemplary customer object described above typically comprises text. Accordingly, the logical type identifier for the customer name field can be “text.” Additional logical type identifiers can include Boolean, enumeration, and numeric. Other logical type identifiers are within the scope of the present invention. A Boolean logical type identifier can be used for a true/false field, such as a checkbox. An enumeration logical type identifier can be used to identify a defined set of items associated with a field. For example, an order status field can comprise a defined set of “shipped,” “back-ordered,” or “waiting payment.” One of those options can be selected to indicate the value for the order status field. A numeric logical type identifier can be used for a field comprising an integer or decimal information.

The logical form metadata 203, 204 also can include additional information for displaying the field. For example, the additional information can include a tab index, a label, and a tool tip. The tab index can define the field order as a user tabs through fields on the user interface 212, 220. The label can specify the displayed text and can describe what the value of the field represents. The tool tip can provide additional information (usually in a popup) about how the field's value is used. The label and the tool tip also can be provided in the smart object metadata 202.

The logical form metadata 203, 204 can allow blanket changes to a field's physical control type without hand modifying each user interface on which the field appears. For example, a text field can be changed to a numeric field by changing the logical type identifier of the field in the logical form metadata 203, 204. The new physical control type can then be carried forward to appear on each user interface 212, 220. Each user interface 212, 220 does not have to be separately updated.

In an exemplary embodiment, the logical form metadata 203, 204 does not include any information regarding how the form appears on the user interface 212, 220. Accordingly, the logical form metadata 203, 204 does not include information regarding the specific layout and appearance of the fields on the user interface 212, 220. Thus, the logical form metadata 203, 204 does not change when the target display client changes. For example, if the target display client is changed from Microsoft® Internet Explorer to a Microsoft® Win32 application, then the same logical form metadata can be used.

The system 200 also can include one or a plurality of layout metadata 206, 214 associated with each logical form metadata 203, 204. For simplicity, FIG. 2 depicts only the layout metadata 206, 214 associated with the logical form metadata 204. However, the logical form metadata 203 also can be associated with layout metadata (not shown). The layout metadata 206, 214 can be provided for a particular renderer 210, 218, respectively.

The layout metadata 206, 214 can describe the layout relationships of the fields on the form. The layout metadata 206, 214 can define how controls associated with the fields of the logical form metadata 204 are positioned on the user interface 212, 220, respectively. The layout metadata 206, 214 can comprise layout information for a layout geometry that can be used by renderer 210, 218, respectively.

In an exemplary embodiment, layout metadata 206 can comprise an absolute positioning layout geometry, and the layout metadata 214 can comprise a table flow layout geometry. Microsoft® Win32 is an example of a display client that uses absolute positioning layout geometry. In absolute positioning layout geometry, the layout metadata can comprise x and y coordinates that indicate the position of a field on the user interface 212. HTML is an example of a display client that uses the table flow layout geometry. In the table flow layout geometry, the layout metadata can comprise information regarding the relative positions of fields on the user interface 220. For example, the fields can be grouped together and positioned on the user interface in a row/column format.

The layout metadata 206, 214 can be reusable between display clients that have similar layout geometries. For example, if the layout metadata 214 comprises a table flow layout geometry, then layout metadata 214 can be used by any display client that uses the table flow layout geometry. The renderer 218 can consume the table flow layout geometry of layout metadata 214 and can provide that information to table flow display clients. Accordingly, if a new table flow display client is added to the system, the layout metadata associated with the layout geometry of the new display client can be used without modification.

In an exemplary embodiment, the layout metadata 206, 214 does not include information that is provided in the smart object metadata 202 or the logical form metadata 204. For example, the layout metadata 206, 214 does not include information regarding the state of the fields in the smart object 201 or the type of physical control that can represent each field on the user interface 212, 220.

The system 200 also can include physical control metadata 208, 216 for the layout metadata 206, 214, respectively. The physical control metadata 216 can comprise information that maps the logical form identifier of a field from the logical form metadata 204 to a physical control of the renderer 218. For example, if the field comprises text information, then the physical control can be a text box. Accordingly, the physical control metadata 216 can comprise information that maps the field ID of the text field to a text box of renderer 218. The physical control metadata 208 operates similarly for renderer 210.

The system 200 also can include physical settings metadata 209, 217. The physical settings metadata 217 can provide information about the physical appearance and behavior of the physical controls that represent the fields displayed by the renderer 218. The physical settings metadata 217 can include information that is specific to the particular renderer 218. For example, the physical settings metadata 209 can provide information such as font size and font type for a text box physical control displayed by the renderer 218. The physical settings metadata 209 operates similarly for renderer 210.

In system 200, the renderer 218 can combine the smart object metadata 202, the logical form metadata 204, the layout metadata 214, the physical control metadata 216, and the physical settings metadata 217 to produce the form that is displayed on the user interface 220. Similarly, the renderer 210 can combine the smart object metadata 202, the logical form metadata 204, the layout metadata 206, the physical control metadata 208, and the physical settings metadata 209 to produce the form that is displayed on the user interface 212. When generating the user interface 212, 220, the renderer also can read and implements the field data from the smart object 201.

In an exemplary embodiment, renderer 218 can read the logical form metadata 204 to determine which fields of the smart object 201 will be included on the form displayed on the user interface 220. The renderer 218 can read the layout metadata 214 to determine the locations of the fields on the user interface 220. The renderer 218 can read the physical control metadata 216 to determine the physical control for each field displayed on the user interface 220. The renderer 218 can read the physical settings metadata 217 to determine the physical settings for the physical controls. Finally, the renderer 218 can read the field data from smart object 201 and the field state from smart object metadata 202. The renderer can then display each field on the user interface 220 based on the read information.

The system 200 described in FIG. 2 can provide a smart object that can contain the only copy of the core application program logic. The functionality of that logic can be used in multiple forms on multiple rendering systems. The system 200 can operate without the duplicative glue code used to generate conventional user interfaces.

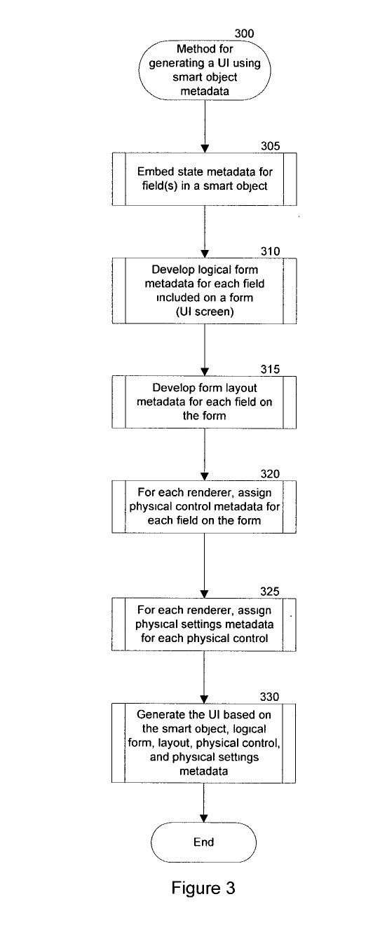

FIG. 3 is a flowchart depicting a method 300 for generating a user interface using smart object metadata according to an exemplary embodiment of the present invention. In step 305, the method 300 can embed state information for a field in the smart object metadata 202 of the smart object 201. In step 310, the method 300 can develop logical form metadata 203, 204 for each field included on a form (a screen of a user interface). Then in step 315, layout metadata 206, 214 can be developed for each field on the form. For each renderer 210, 218, the method 300 can assign in step 320 physical control metadata 208, 218 for each field on the form. Also for each renderer 210, 218, the method 300 can assign in step 325 physical settings metadata 209, 217 for each physical control. Finally in step 330, the renderer 210, 218 can generate the form on the user interface 212, 220 based on the smart object metadata, the logical form metadata, the layout metadata, the physical control metadata, and the physical settings metadata.

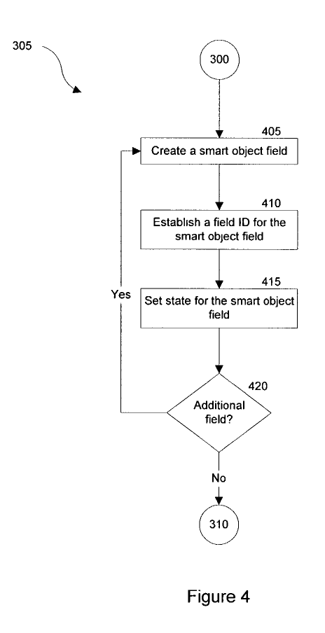

FIG. 4 is a flowchart depicting a method for embedding state smart object metadata 202 for fields in a smart object 201 according to an exemplary embodiment of the present invention, as referred to in step 305 of FIG. 3. In step 405, a designer can create a smart object field to include in the smart object 201. For example, a designer can create a customer name field to include in a customer smart object. Also in step 405, the smart object fields can be created using object oriented programming. In step 410, the designer can establish a field ID for the smart object field. For example, the designer can associate a field ID of “customer_nameID” to the customer name field. Then in step 415, the designer can set a state for the smart object field.

In an exemplary embodiment, states for smart object fields can include “must write,” “read/write,” and “read only,” as discussed above. Step 415 can involve associating the state of a particular smart object field with its field ID. If a field has a “must write” (required) state, then a user can be prevented from moving to another field until a value is entered in the required field. In other words, the field is empty, and a user must provide a value for the field. If a field has a “read/write” (enabled control) state, then the user will be able to read and edit information in the field. If a field has a “read only” (disabled control) state, then a user will not be able to input or to edit information in the field.

A field can have different states defined for use in different user interface forms. Additionally, the state of a field can be dependent upon a value entered into another field. For example, a line item field on an order form can initially have a disabled control state until a user inputs a customer name into the customer name field. After the customer name field contains a valid value, then the state of the line item field can change to required.

In step 420, the method can determine whether to create an additional field in the smart object 201. If so, then the method can branch back to step 405 to create another smart object field. If an additional field will not be created, then the method can branch to step 310 (FIG. 3).

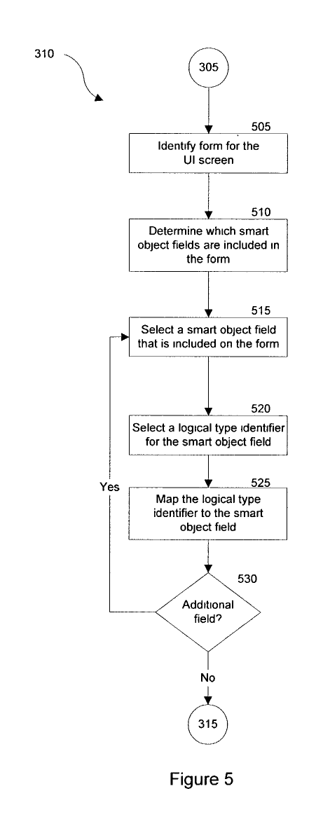

FIG. 5 is a flowchart depicting a method for developing logical form metadata 203, 204 according to an exemplary embodiment of the present invention, as referred to in step 310 of FIG. 3. In step 505, the method can identify a form for the user interface screen. For example, the method can identify whether the form comprises the customer maintenance form or the order form. In step 510, the method can determine which smart object fields are included on the selected form. For example, if step 505 identified the form as a customer maintenance form, then step 510 can determine that fields on the form include customer name, customer ID, address, city, state, zip code, e-mail address, credit card number, and other customer information fields.

In step 515, the method can select a smart object field from the form. Then in step 520, the method can select a logical type identifier for the smart object field. The logical type identifier can identify the type of physical control to represent the field on the user interface 212, 220. For example, the customer name field typically comprises text. Accordingly, the logical type identifier for the customer name field can be “text.” Additional logical type identifiers can include Boolean, enumeration, and numeric, as discussed above. Other logical type identifiers are within the scope of the present invention.

In step 525, the logical type identifier can be mapped to the smart object field. For example, the field ID can be associated to the logical type identifier. Then in step 530, the method can determine whether to develop logical form metadata for an additional field on the form. If yes, then the method can branch back to step 515. If not, then the method can branch to step 315 (FIG. 3).

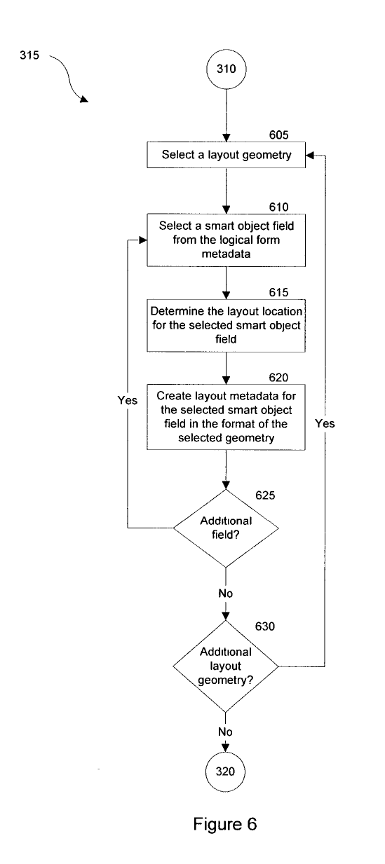

FIG. 6 is a flowchart depicting a method for developing layout metadata 206, 214 according to an exemplary embodiment of the present invention, as referred to in step 315 of FIG. 3. In step 605, a layout geometry can be selected. For example, an absolute positioning layout geometry or a table flow layout geometry can be selected. Then in step 610, a smart object field from the logical form metadata 203, 204 can be selected. In step 615, the layout location on the form of the selected smart object field can be determined. In step 620, the layout metadata for the selected smart object field can be developed in the format of the selected geometry. For example, the method can develop x and y coordinate information if the selected geometry is absolute positioning. Alternatively, the method can develop relative positioning information for table flow layout geometry.

In step 625, the method can determine whether to develop layout metadata for an additional field. If so, then the method can branch back to step 610. If not, then the method can branch to step 630. In step 630, the method can determine whether to develop layout metadata for an additional layout geometry. If so, then the method can branch back to step 605. If not, then the method can branch to step 320 (FIG. 3).

In an exemplary embodiment, the renderer 210, 218 can infer the layout metadata 206, 214 from the logical form metadata 203, 204. For example, the relative positions of the smart object fields on the form can be inferred from an order of the smart object fields in the logical form metadata 203, 204. In that exemplary embodiment, the renderer 210, 218 can render the smart object fields on the user interface 212, 220 in the order presented in the logical form metadata 203, 204. Accordingly, the creation of separate layout metadata 206, 214 can be avoided.

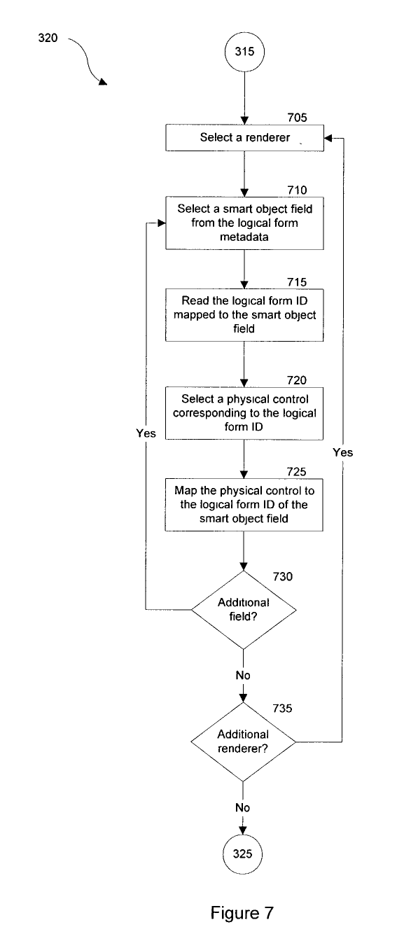

FIG. 7 is a flowchart depicting a method for assigning physical control metadata 208, 216 according to an exemplary embodiment of the present invention, as referred to in step 320 of FIG. 3. In step 705, the method can select a renderer 210, 218 for a particular display client. Then in step 710, the method can select a smart object field from the logical form metadata 203, 204. The logical form identifier mapped to the smart object field can be read in step 715. Then in step 720, the method can select a physical control corresponding to the logical form identifier. For example, if the logical form identifier indicates “text,” then a text box physical control can be selected. In step 725, the physical control can be mapped to the logical form identifier of the smart object field by associating the field ID with the physical control.

In step 730, the method can determine whether to assign physical control metadata for an additional field. If so, then the method can branch back to step 710. If not, then the method can branch to step 735. In step 735, the method can determine whether to assign physical control metadata for an additional renderer for another particular display client. If so, then the method can branch back to step 705. If not, then the method can branch to step 325 (FIG. 3).

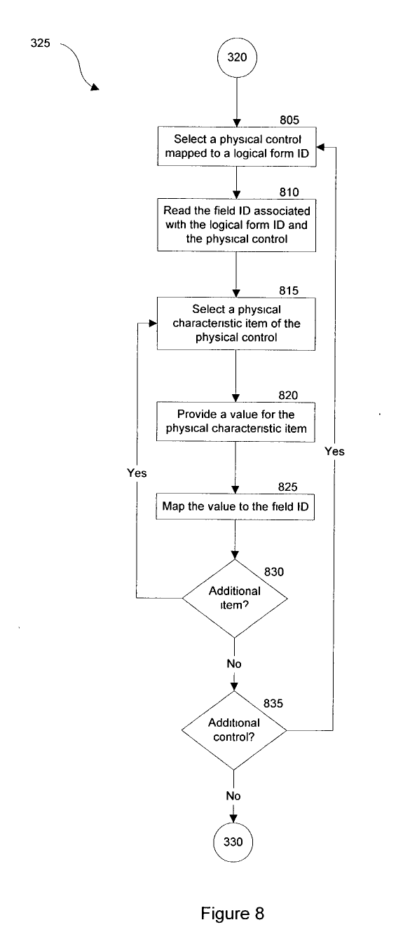

FIG. 8 is a flowchart depicting a method for assigning physical settings metadata 209, 217 according to an exemplary embodiment of the present invention, as referred to in step 325 of FIG. 3. In step 805, the method can select a physical control mapped to a logical form identifier. In step 810, the method can read the field ID associated with the logical form identifier and the physical control. In step 815, a physical characteristic item of the physical control can be selected. For example, if the physical control comprises a text box, a physical characteristic can be font style, font size, or other text characteristic. Then in step 820, the method can provide a value for the physical characteristic item. For example, a font style physical characteristic item can be provided a value of “Arial.” In step 825, the method can map the value for the physical characteristic item to the field ID of the smart object field.

In step 830, the method can determine whether to assign physical control settings metadata for an additional physical characteristic item of the physical control. If yes, then the method can branch back to step 815. If not, then the method can branch to step 835. In step 835, the method can determine whether to assign physical settings metadata for an additional physical control. If yes, then the method can branch back to step 805. If not, then the method can branch to step 330 (FIG. 3).

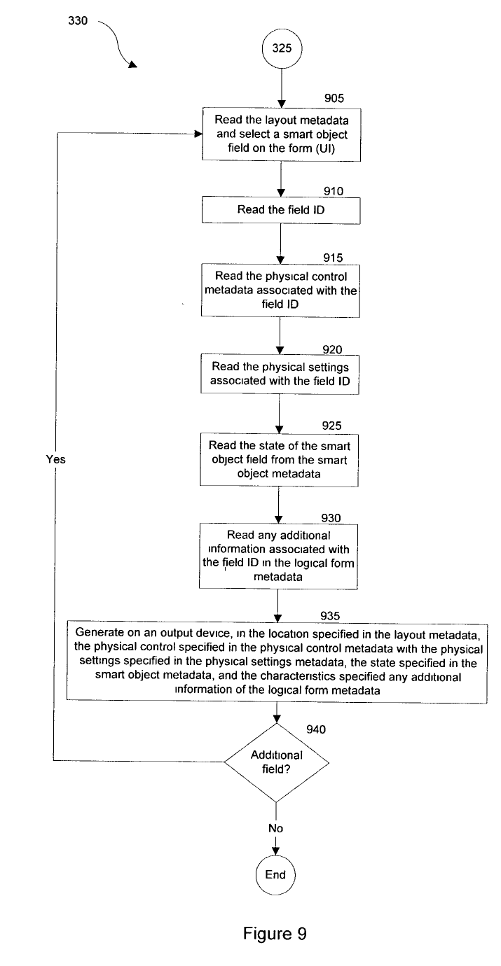

FIG. 9 is a flowchart depicting a method for generating a user interface form on the user interface 212, 220 according to an exemplary embodiment of the present invention, as referred to in step 330 of FIG. 3. The method of FIG. 9 will be described with reference to the renderer 218 of FIG. 2. In step 905, the renderer 218 can read the layout metadata 214 and can select a smart object field on the form. In an exemplary embodiment using a table flow layout geometry, the first field on the form will typically be selected because the fields are positioned relative to each other. In an exemplary embodiment using an absolute positioning layout geometry, the selection order of the fields can be more random because the fields are positioned based on coordinates.

In step 910, the renderer 218 can read the field ID of the selected smart object field. In step 915, the renderer 218 can read the physical control metadata 216 associated with the field ID of the selected smart object field. In step 920, the renderer can read the physical settings metadata 217 associated with the field ID of the selected smart object field. In step 925, the renderer can read the state of the selected smart object field from the smart object metadata 202. Also in step 925, the renderer 218 can read the field data from the smart object 201. In step 930, the renderer 218 can read any additional information associated with the field ID in the logical form metadata 204. For example, the additional information can include the tab index, label, or tool tip discussed above.

Then in step 935, the renderer 218 can generate the field on the user interface 220. The renderer 218 can generate the field on the user interface 220 by generating the physical control specified in the physical control metadata 216. The physical control can be generated in the location specified in the layout metadata 214 and with the physical settings specified in the physical settings metadata 217. The physical control also can be generated with the state specified in the smart object metadata 202 and the characteristics specified in any additional information of the logical form metadata 204.

In step 940, the method can determine whether to generate an additional field on the user interface 220. If yes, then the method can branch back to step 905. If not, then the method of generating a user interface using smart object metadata can end.

An exemplary embodiment of generating a field on the user interface 220 will be described for generating a text box representing the customer name field of the exemplary customer smart object. The renderer can select the customer name field to display on the user interface 220. The renderer can read the physical control metadata mapped to the customer name field ID to determine that the physical control comprises a text box. The renderer 218 can read the physical settings associated with the customer name field ID from the physical settings metadata stored in a physical settings file. The renderer 218 can read the layout metadata indicating the position of the customer name field on the user interface 220. The renderer also can read data associated with the customer name field from the customer smart object. The renderer 218 can then generate the text box physical control on the user interface 220 in the location specified in the layout metadata and having the physical settings specified in the physical settings metadata. The renderer 218 also can assign the state of the customer name field specified in the smart object metadata.

Blanket changes to a user interface can be made using the system and method described herein. Metadata mappings can be changed in one location to automatically update the desired user interface screens. Additionally, blanket changes can be targeted at particular areas of the product without being global in nature. For example, the customer smart object and its associated metadata can be changed in one place, and the customer smart object will be updated throughout the product. Such global change capability also applies at the user interface control level, because the mappings to physical controls are metadata based. For example, an old text box physical control can be replaced across the system with a more modern-looking control simply by changing one piece of physical control metadata.

In the smart object metadata driven user interface framework described herein, the description of how an application will operate and interact with its users can be provided in metadata as part of the smart object and not in a separate user interface architecture. Accordingly, the functionality of the application can be decoupled from fragile user interface rendering technology.

The present invention can be used with computer hardware and software that performs the processing functions described above. As will be appreciated by those skilled in the art, the systems, methods, and procedures described herein can be embodied in a programmable computer, computer executable software, or digital circuitry. The software can be stored on computer readable media. For example, computer readable media can include a floppy disk, RAM, ROM, hard disk, removable media, flash memory, memory stick, optical media, magneto-optical media, CD-ROM, etc. Digital circuitry can include integrated circuits, gate arrays, building block logic, field programmable gate arrays (FPGA), etc.

Although specific embodiments of the present invention have been described above in detail, the description is merely for purposes of illustration. Various modifications of, and equivalent steps corresponding to, the disclosed aspects of the exemplary embodiments, in addition to those described above, may be made by those skilled in the art without departing from the spirit and scope of the present invention defined in the following claims, the scope of which is to be accorded the broadest interpretation so as to encompass such modifications and equivalent structures.

What is claimed is:

1. A computer-implemented method for generating a form on a user interface, the user interface displaying a field of the form, said method comprising the steps of:
developing logical form metadata for the field that identifies a data type associated with the field;
developing layout metadata for the field that identifies a location of the field on the user interface;
assigning physical control metadata to the field that identifies a physical control to represent the field on the user interface, the physical control being of the data type indicated by the logical form metadata; and
generating the field on the user interface by rendering the physical control identified by the physical control metadata in the location identified by the layout metadata.

2. The method according to claim 1, wherein said step of developing logical form metadata comprises the steps of:
selecting a logical type identifier for the data type associated with the field; and
mapping the logical type identifier to the field.

3. The method according to claim 2, further comprising the step of creating a field identifier for the field,
wherein said mapping step comprises associating the logical type identifier with the field identifier.

4. The method according to claim 1, wherein said step of developing layout metadata comprises the steps of:
selecting a layout geometry used to display the form on the user interface; and
creating layout metadata for the field in the format of the selected geometry.

5. The method according to claim 4, wherein the selected geometry comprises one of absolute positioning and table flow.

6. The method according to claim 5, wherein the selected geometry comprises absolute positioning, and
wherein said creating step comprises creating coordinates that indicate the location of the field on the user interface.

7. The method according to claim 5, wherein the selected geometry comprises table flow, and
wherein said creating step comprises creating location information based on the relative position of the field to another field on the user interface.

8. The method according to claim 1, wherein said step of assigning physical control metadata comprises the steps of:
selecting a physical control to represent the field; and
mapping the physical control to the logical form metadata of the field.

9. The method according to claim 8, further comprising the step of creating a field identifier for the field,
wherein said mapping step comprises associating the physical control with the field identifier.

10. The method according to claim 1, further comprising the step of embedding state metadata for the field in a smart object, the state metadata indicating an attribute of the field,
wherein said generating step comprises rendering the field based on the state metadata.

11. The method according to claim 10, wherein the attribute of the field comprises one of “must write,” “read/write,” and “read only.”

12. The method according to claim 10, wherein the attribute comprises “must write” and indicates that a value associated with the field is required and not currently entered.

13. The method according to claim 10, wherein the attribute comprises “read/write” and indicates enabled control of the field.

14. The method according to claim 10, wherein the attribute comprises “read only” and indicates disabled control of the field.

15. The method according to claim 1, further comprising the step of assigning physical settings metadata to the physical control that identifies presentation characteristics of the physical control,
wherein said generating step comprises rendering the physical control on the user interface based on the physical settings metadata.

16. A computer-readable medium having computer-executable instructions for performing the method of claim 15.

17. A system for generating a form, comprising:
a user interface that displays the form; and
a processor running a program module, the program module comprising:
state metadata that identifies an attribute of the field,
layout metadata that identifies a location of the field on the user interface, and
physical control metadata that identifies a physical control to represent the field on the user interface, and
a renderer that generates the field on the user interface by displaying the physical control identified by the physical control metadata in the location identified by the layout metadata and with the attribute identified by the state metadata.

18. The system according to claim 17, wherein the attribute of the field comprises one of “must write,” “read/write,” and “read only.”

19. The system according to claim 17, wherein the program module further comprises physical settings metadata that identifies a presentation characteristic of the physical control, and
wherein said renderer generates the physical control on the user interface based on the physical settings metadata.

20. The system according to claim 17, wherein the program module further comprises logical form metadata that identifies a data type associated with the field, and
wherein the physical control metadata identifies a physical control of the data type identified by the logical form metadata.

21. The system according to claim 20, wherein the program module further comprises a field identifier for the field, and
wherein the logical form metadata is associated with the field identifier.

22. The system according to claim 20, wherein the program module further comprises a field identifier for the field, and
wherein the logical form metadata and the physical control are associated with the field identifier.

23. The system according to claim 17, wherein the layout metadata comprises location information in the format of a specified layout geometry.

24. The system according to claim 23, wherein the specified geometry comprises one of absolute positioning and table flow.

25. The system according to claim 24, wherein the specified geometry comprises absolute positioning, and
wherein the location information comprises coordinates that indicate the location of the field on the user interface.

26. The system according to claim 24, wherein the specified geometry comprises table flow, and
wherein the location information indicates the relative position of the field to another field on the user interface.

27. A computer-readable medium having computer-executable instructions for performing a method for generating a form on a user interface, the user interface displaying a field of the form, said method comprising the steps of:
embedding state metadata for the field in a smart object, the state metadata indicating an attribute of the field;
developing logical form metadata for the field that identifies a data type associated with the field;
developing layout metadata for the field that identifies a location of the field on the user interface;
assigning physical control metadata to the field that identifies a physical control to represent the field on the user interface, the physical control being of the data type indicated by the logical form metadata; and
generating the field on the user interface by rendering the physical control identified by the physical control metadata in the location identified by the layout metadata and having the attribute identified by the state metadata.

28. The computer-readable medium according to claim 27, wherein said step of developing logical form metadata comprises the steps of:
selecting a logical type identifier for the data type associated with the field; and
mapping the logical type identifier to the field.

29. The computer-readable medium according to claim 28, wherein said method further comprises the step of creating a field identifier for the field, and
wherein said mapping step comprises associating the logical type identifier with the field identifier.

30. The computer-readable medium according to claim 27, wherein said step of developing layout metadata comprises the steps of:
selecting a layout geometry used to display the form on the user interface; and
creating layout metadata for the field in the format of the selected geometry.

31. The computer-readable medium according to claim 30, wherein the selected geometry comprises one of absolute positioning and table flow.

32. The computer-readable medium according to claim 31, wherein the selected geometry comprises absolute positioning, and
wherein said creating step comprises creating coordinates that indicate the location of the field on the user interface.

33. The computer-readable medium according to claim 31, wherein the selected geometry comprises table flow, and
wherein said creating step comprises creating location information based on the relative position of the field to another field on the user interface.

34. The computer-readable medium according to claim 27, wherein said step of assigning physical control metadata comprises the steps of:
selecting a physical control to represent the field; and
mapping the physical control to the logical form metadata of the field.

35. The computer-readable medium according to claim 34, wherein said method further comprises the step of creating a field identifier for the field, and
wherein said mapping step comprises associating the physical control with the field identifier.

36. The computer-readable medium according to claim 27, wherein the attribute of the field comprises one of “must write,” “read/write,” and “read only.”

37. The computer-readable medium according to claim 27, wherein the attribute comprises “must write” and indicates that a value associated with the field is required and not currently entered.

38. The computer-readable medium according to claim 27, wherein the attribute comprises “read/write” and indicates enabled control of the field.

39. The computer-readable medium according to claim 27, wherein the attribute comprises “read only” and indicates disabled control of the field.

40. The computer-readable medium according to claim 27, wherein said method further comprises the step of assigning physical settings metadata to the physical control that identifies presentation characteristics of the physical control, and
wherein said generating step comprises rendering the physical control on the user interface based on the physical settings metadata.

41. A computer-implemented method for generating a form on a user interface, the user interface displaying a field of the form, said method comprising the steps of:
developing logical form metadata for the field that identifies a data type associated with the field;
assigning physical control metadata to the field that identifies a physical control to represent the field on the user interface, the physical control being of the data type indicated by the logical form metadata; and
generating the field on the user interface by rendering the physical control identified by the physical control metadata.

42. The method according to claim 41, wherein said step of developing logical form metadata comprises the steps of:
selecting a logical type identifier for the data type associated with the field; and
mapping the logical type identifier to the field.

43. The method according to claim 42, further comprising the step of creating a field identifier for the field,
wherein said mapping step comprises associating the logical type identifier with the field identifier.

44. The method according to claim 41, wherein said step of assigning physical control metadata comprises the steps of:
selecting a physical control to represent the field; and
mapping the physical control to the logical form metadata of the field.

45. The method according to claim 44, further comprising the step of creating a field identifier for the field,
wherein said mapping step comprises associating the physical control with the field identifier.

46. The method according to claim 41, further comprising the step of embedding state metadata for the field in a smart object, the state metadata indicating an attribute of the field,
wherein said generating step comprises rendering the field based on the state metadata.
